(19) United States
(12) Patent Application Publication
(10) Pub. No.: US 2005/0146862 A1
(43) Pub. Date: Jul. 7, 2005

(54) Balloon decoration with inner lighting apparatus

(76) Inventor: Yu-Peng Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/752,014

(22) Filed: Jan. 7, 2004

(51) Int. Cl. F21V 33/00

(52) U.S. Cl. 362/101; 362/806; 362/363; 362/809; 362/811; 362/812

(57) ABSTRACT

The invention relates to a balloon decoration with inner lighting apparatus includes a balloon decoration and a positioning rod. The balloon decoration is provided with an inner space and the rod having at least one projective ring is received in the space and will be firmly engaged within the balloon as the balloon is filled with air. A light string is put inside the rod for providing a lighting effect through the rod and the balloon.

### BACKGROUND OF THE INVENTION

A conventional balloon decoration is a plastic film having various patterns. When the balloon is filled with air, it shows a three-dimension body for decorative effect. If we need the balloon decoration to combine a light string to provide a special object, a further frame must be used to connect the light string with the balloon decoration. The way of such connection by the frame seems inconvenient and uneconomic.

Accordingly, the present invention is to provide a new balloon decoration, which can receive a light string inside the balloon easily and firmly. Now, accompanying with the following drawings, the character of the present invention will be described here and after.

### BRIEF DESCRIPTION OF THE DRAWINGS

FIG. 1 is a cross-sectional plan view showing a balloon decoration with a positioning rod according to the present invention.

FIG. 2 is a plan view of FIG. 1 showing the balloon filled up.

FIG. 3 is a perspective view of FIG. 2.

FIG. 4 is a plan view showing an embodiment according to the present invention.

FIG. 5 is a plan view showing another embodiment according to the present invention.

### DETAILED DESCRIPTION OF THE PREFERRED EMBODIMENT

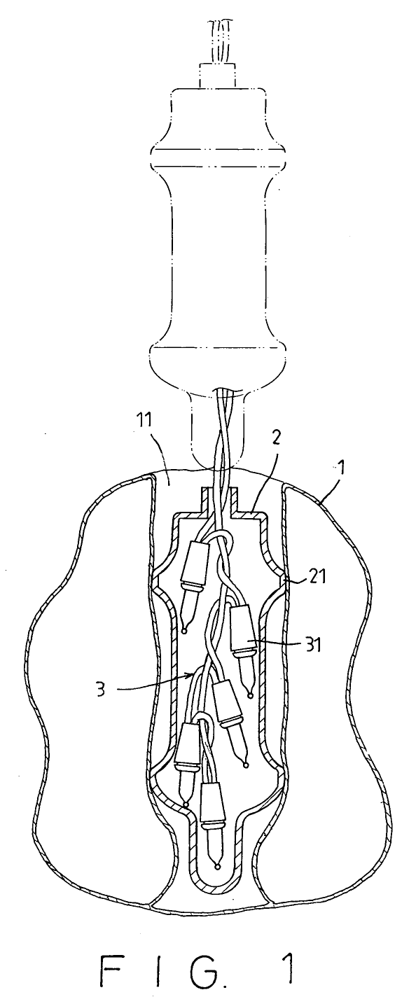

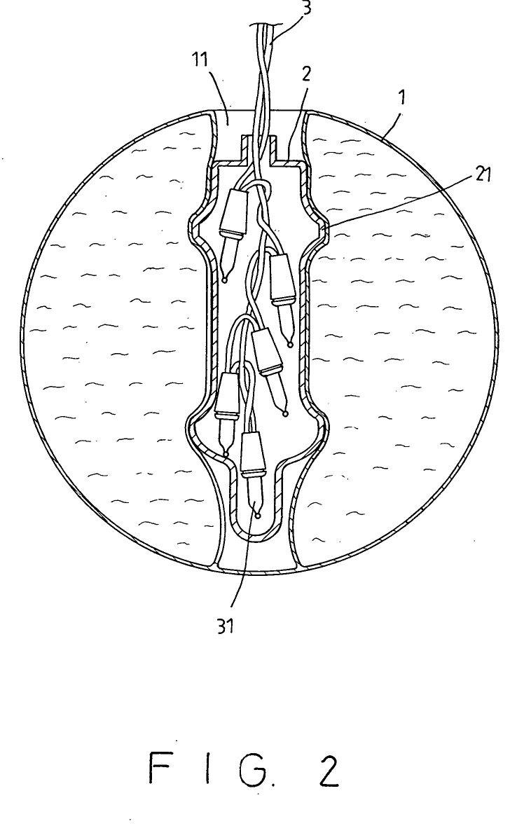

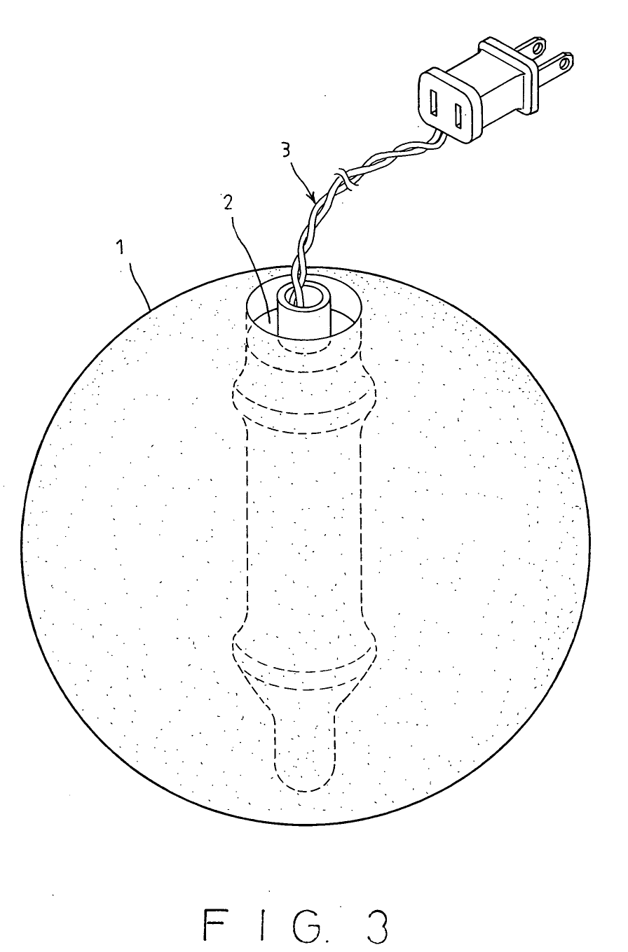

Please referring to FIG. 1 to 3, the present invention relates to a balloon decoration (1), which is made of plastic material and can be any desired patterns for special decorative purpose when it is filled with air to be a three-dimension body. In this specification, the balloon decoration (1) is illustrated to be a ball for easy description. The balloon decoration (1) is provided with an independent inner space (11) for receiving a positioning rod (2), which includes at least one projective ring (21). Since the surface of the balloon decoration (1) is soft, the inner surface of the space (21) can completely contact with the positioning rod (2). By use of the engagement between the surface of inner space (11) of the balloon (1) and the projective ring (21) of the rod (2), the rod (2) is then engaged with the balloon (1) firmly and any extra frame is necessary.

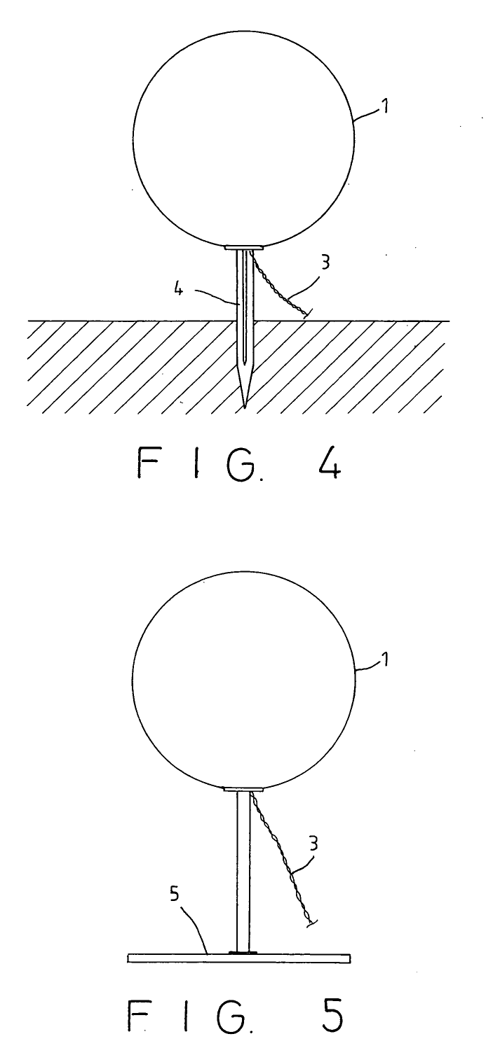

Accordingly, it is the most character of the present invention that the light string (3) received in the rod (2) can be easily positioned in the balloon (1) as soon as the balloon (1) is filled with air. It is not necessary to use a further rigid frame to connect both together. Hence, the present invention is utilized and effective. In application, the balloon decoration (1) can be hung for decorative effect. It also can connect a leg (4) with the rod (2) for inserting into the ground, such as shown in FIG. 4, or connect with a support (5) for placing on table while the bulb assembly (31) of the string (3) is lighting to display the novel decorative effect.

1. A balloon decoration with inner lighting apparatus including a balloon decoration and a positioning rod, wherein the balloon decoration is provided with an inner space and the rod having at least one projective ring is received in the space and is firmly engaged within the balloon as the balloon is filled with air, and a light string being put inside the rod.

2. A balloon decoration with inner lighting apparatus as claimed in claim 1, wherein a leg is connected with the rod for inserting into the ground for decoration.

3. A balloon decoration with inner lighting apparatus as claimed in claim 1, wherein a support is connected with the rod for placing on table.
